(19) United States
(12) Patent Application Publication
(10) Pub. No.: US 2025/0280397 A1
(43) Pub. Date: Sep. 4, 2025

(54) METHODS AND APPARATUS FOR L1 SECURITY ENHANCEMENT

(71) Applicant: APPLE INC., Cupertino, CA (US)

(72) Inventors: Weidong Yang, San Diego, CA (US); Wei Zeng, San Diego, CA (US); Fangli Xu, Beijing (CN); Shu Guo, Beijing (CN); Dawei Zhang, Saratoga, CA (US); Sarma V Vangala, Campbell, CA (US); Haijing Hu, Los Gatos, CA (US); Huarui Liang, Beijing (CN); Amir Farajidana, Sunnyvale, CA (US); Oghenekome Oteri, San Diego, CA (US); Bobby Jose, Cupertino, CA (US); Naveen Kumar R Palle Venkata, San Diego, CA (US); Ralf Rossbach, Munich (DE); Pavan Nuggehalli, San Carlos, CA (US)

(21) Appl. No.: 18/859,240

(22) PCT Filed: Apr. 28, 2023
(86) PCT No.: PCT/US2023/066331

§ 371 Date: Oct. 23, 2024

Related U.S. Application Data
(60) Provisional application No. 63/363,833, filed on Apr. 29, 2022.

(51) Int. Cl. H04W 72/0446; H04W 72/21; H04W 72/23

(52) U.S. Cl. CPC H04W 72/0446; H04W 72/21; H04W 72/23

(57) ABSTRACT

Communicating in a wireless communication system includes generating at least one of a time-varying radio network temporary identifier (RNTI) and a time-varying identifier (ID), seeding a scrambling sequence with the at least one of the time-varying RNTI and the time-varying ID, scrambling a physical channel or a reference signal using the scrambling sequence, and transmitting the physical channel or the reference signal. A common key between a base station and a user equipment (UE) may be derived. Generating the time-varying RNTI may include using a function based on the common key, an RNTI, and a time variable.

### TECHNICAL FIELD

This application relates generally to wireless communication systems, including physical layer (i.e., L1) security.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a table illustrating the status of access stratum (AS) security protection for certain wireless communication systems.

FIG. 2 is a block diagram illustrating physical layer processing of PDCCH used by certain wireless systems.

FIG. 3 is a block diagram illustrating physical layer processing of PDSCH used by certain wireless systems.

FIG. 4 is a timing diagram illustrating a process for L1 (i.e., physical layer) security according to certain embodiments.

FIG. 5 is a block diagram illustrating physical layer processing of PDCCH according to certain embodiments.

FIG. 6 is a block diagram illustrating physical layer processing of PDSCH according to certain embodiments.

FIG. 7 is a block diagram illustrating physical layer processing of PUSCH according to certain embodiments.

FIG. 8 is a block diagram illustrating physical layer processing of PUCCH according to certain embodiments.

FIG. 9 illustrates an example architecture of a wireless communication system, according to embodiments disclosed herein.

FIG. 10 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

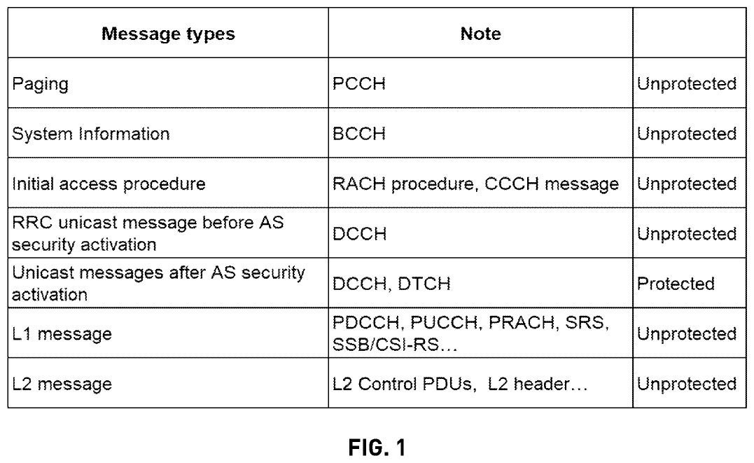

FIG. 1 is a table illustrating the status of access stratum (AS) security protection for certain wireless communication systems. As shown, only unicast transmissions after AS security activation are protected. The protected unicast messages may include, for example, a dedicated control channel (DCCH) and a dedicated traffic channel (DTCH). However, other message types may remain unprotected including paging (e.g., paging control channel (PCCH)), system information (e.g., broadcast control channel)), initial access procedures (e.g., random access channel (RACH) procedure and/or common control channel (CCCH) message), radio resource control (RRC) unicast messages before AS security activation (e.g., DCCH), L1 messages (e.g., physical downlink control channel (PDCCH), physical uplink control channel (PUCCH), physical radio access channel (PRACH), sounding reference signal (SRS), synchronization signal block (SSB), channel state information reference signal (CSI-RS), etc.), and L2 messages (e.g., L2 control protocol data units (PDUs), L2 header, etc.).

Current AS security configurations may include integrity protection and cyphering of RRC signaling (e.g., signaling radio bearers (SRBs)) and user data (e.g., data radio bearers (DRBs)). The AS security mode command (SMC) procedure is for RRC and user plane (UP) security algorithms negotiation and RRC security activation. The security configuration is per DRB, but all the DRBs belonging to the same PDU session may have the same configuration. The integrity protection algorithm and ciphering algorithm are common for SRB1, SRB2, SRB3 (if configured), and DRBs configured with integrity protection with the same keyToUse value.

Currently an unauthorized downlink receiver with sufficient computing resources can identify the PDCCH resources used in a deployment and decode the PDCCH and physical downlink shared channel (PDSCH) of all the users in a network. L2 Headers (lower than the packet data convergence protocol (PDCP) layer can be fully parsed based on common deployments, even if a dedicated configuration is ciphered. Further, media access control (MAC) control elements (CEs) are not protected.

In certain wireless communication systems, adding ciphering and integrity protection to downlink control information (DCI) may not be feasible. For example, adding ciphering and integrity protection to DCI may add significant overhead to the blind decoding, may produce additional latency to critical UE processing deadlines for N1 and N2, and/or may require extra bits for integrity checksum. Thus, the inventors of the present application recognized the need for physical layer security enhancement to significantly increase the computational complexity for an unauthorized downlink receiver to identify and track individual users in a network.

Another security risk is that a fake base station can send fake L1 and/or L2 messages to conduct denial of service (DOS) attack on a UE. Further, a fake UE can send fake L1/L2 messages to conduct a DOS attack on a base station. (e.g., gNB). Thus, the inventors of the present application recognized the need for physical layer security enhancement to significantly increase the computational complexity for a fake base station and/or fake UE to conduct a DOS attack.

In downlink (DL), an L1 (i.e., physical layer) attack strategy may include occupying a large portion or all of the PDCCH candidates in a slot to block the reception of the signal from the legitimate base station. As PDCCH is not protected, the attacker can first read the PDCCH sent to a UE of interest, then fake PDCCH transmission and/or PDSCH transmission (e.g., with the same HARQ process number, correct demodulation reference signal (DMRS) generation, and also correct modulation constellations with a garbage signal), to corrupt the soft buffer of the UE. Thus, either the signal from the base station is overwhelmed by the fake signal (note that the signal strength of the fake signal does not need to be at an elevated level), or the UE just receives the fake signals.

An L2 attack may also occur in DL. As L2 header and L2 control PDUs are not protected, an attacker can pretend to be the serving cell of a UE of interest and send L2 messages to the UE to disrupt its communication with the base station. For example, “SCell Activation/Deactivation MAC CEs” can be used to de-activate the communications over secondary cells (SCells) such that the UE is not be able to receive data over the affected SCells. In another DL L2 attack, erroneous “TCI State Indication for UE-specific PDCCH MAC CE” and/or “TCI States Activation/Deactivation for UE-specific PDSCH MAC CE” can be used to ask the UE to adjust the receive (Rx) beam towards to a direction not favorable to receive the signal from gNB. In another example DL L2 attack, fake “Aperiodic CSI Trigger State Subselection MAC CE” can be used to select codepoints not intended to be used by the base station, so as to create misalignment between base station and the UE in terms of CSI feedback.

For an uplink (UL) L2 attack, an attacker (e.g., fake UE) can masquerade as the UE of interest to send “BFR MAC CEs” to the base station (e.g., gNB), pretending that the UE suffers from control beam failure. By sending the fake “BFR MAC CEs”, the base station can be tricked to start a beam failure recovery (BFR) procedure to disrupt the ongoing communications.

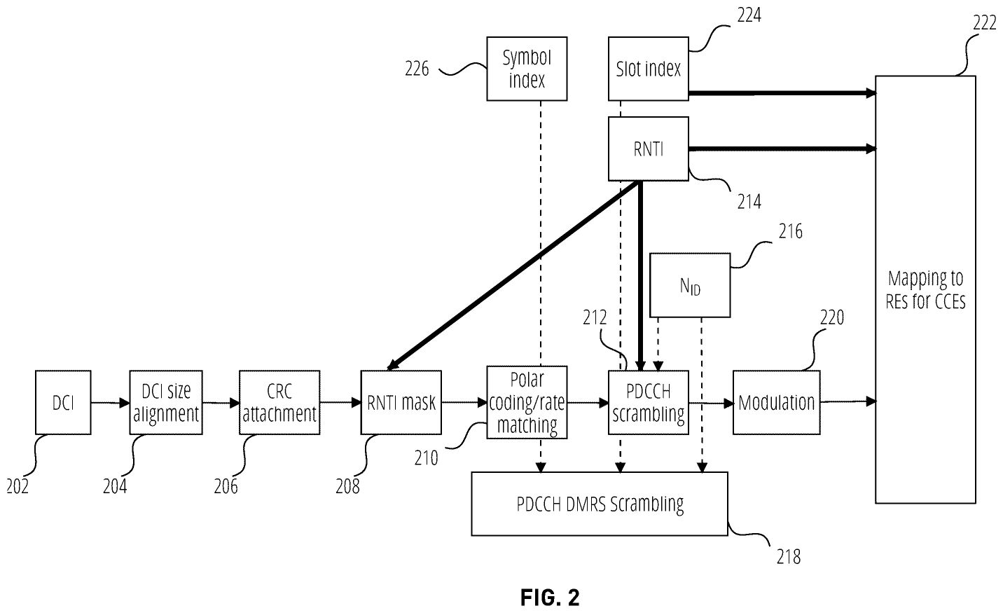

FIG. 2 is a block diagram illustrating physical layer processing of PDCCH used by certain wireless systems. The illustrated example may be performed on DCI 202 by a base station (e.g., gNB). The base station may perform DCI size alignment 204 by adding a few zero padding bits until the payload is a predetermined size. The base station may also calculate a cyclic redundancy check (CRC) and perform CRC attachment 206, which allows a UE to detect the presence of errors in the decoded DCI payload bits. After the CRC is attached, the base station may mask a certain number of the CRC bits with a radio network temporary identifier (RNTI) 214. Using the RNTI mask, for example, the UE can detect the DCI for its unicast data and distinguish sets of DCI with different purposes that have the same payload size. The base station may also perform polar coding/rate matching 210 (e.g., the bits are encoded by a polar encoder to protect the DCI against errors during transmission and then rate matched to fit the allocated payload resource elements (REs) of the DCI).

As shown in FIG. 2, the base station may also perform PDCCH scrambling 212 wherein the payload bits of each DCI are separately scrambled by a scrambling sequence generated from a Gold sequence. The scrambling sequence used to scramble the PDCCH coded bits may be seeded by the RNTI 214 and a scrambling identity N_{ID} 216. In this example, the RNTI 214 and the N_{ID} 216 each have 16 bits.

The Gold sequence may be defined by two polynomials, wherein the seeding may only be for the second polynomial. The seeding of the first polynomial may be fixed. For example, generic pseudo-random sequences may be defined by a length-31 Gold sequence. An output sequence c(n) of length M_{PN}, where n=0, 1, . . . M_{PN}−1, is defined by

$$c ( n ) = ( {x}_{1} ( n + {N}_{C} ) + ( {x}_{2} ( n + {N}_{C} ) ) mod 2 \\ {x}_{1} ( n + 31 ) = ( {x}_{1} ( n + 3 ) + {x}_{1} ( n ) ) mod 2 \\ {x}_{2} ( n + 31 ) = ( {x}_{2} ( n + 3 ) + {x}_{2} ( n + 2 ) + {x}_{2} ( n + 1 ) + {x}_{2} ( n ) ) mod 2$$

where N_{C}=1600 and the first m-sequence, x₁(n), is initialized with x₁(0)=1, x₁(n)=0, n=1, 2, . . . , 30. The initialization of the second m-sequence, x₂(n), is denoted by cᵢₙᵢₜ=Σᵢ₌₀³⁰x₂(i)·2ⁱ with the value depending on the application of the sequence.

The Gold sequence may be extensively used for scrambling in NR. The seed of PDCCH scrambling may be given by n_{RNTI} and n_{ID}. In certain communication systems, the UE assumes a block of bits b(0), . . . , b(M_{bit}−1), where M_{bit} is the number of bits transmitted on the physical channel, is scrambled prior to modulation, resulting in a block of scrambled \tilde{b}(0), . . . , \tilde{b}(M_{bit}−1) according to \tilde{b}(i)=(b(i)+c(i))mod 2 where the scrambling sequence generator is initialized with cᵢₙᵢₜ=(n_{RNTI}·2¹⁶+n_{ID})mod 2³¹. For a UE-specific search space (e.g., as defined in clause 10 of 3GPP TS 38.213), n_{ID}□{0, 1, . . . , 65535} equals the higher-layer parameter pdcch-DMRS-ScramblingID if configured, n_{ID}=N_{ID}^{cell} otherwise. Further, n_{RNTI} is given by UE specific cell RNTI (C-RNTI) for a PDCCH in a UE-specific search space if the higher-layer parameter pdcch-DMRS-ScramblingID is configured, and n_{RNTI}=0 otherwise.

After the PDCCH scrambling 212, the base station performs modulation 220 of the scrambled DCI bit sequence (e.g., using quadrature phase shift keying (QPSK) modulation). The base station then performs mapping 222 to REs for control channel elements (CCEs).

As shown in FIG. 2, the base station also performs PDCCH DMRS scrambling 218. The Gold sequence for PDCCH DMRS is seeded by a slot index 224, a symbol index 226, and the N_{ID} 216. The N_{ID} 216 may be either 16 bits (e.g., configured the same as the C-RNTI) or may follow the size of the cell-ID. In certain embodiments, the UE assumes a reference-signal sequence rₗ(m) for orthogonal frequency division multiplexing (OFDM) symbol l defined by

$${r}_{l} ( m ) = \frac{1}{\sqrt{2}} ( 1 - 2 \cdot c ( 2 m ) ) + j \frac{1}{\sqrt{2}} ( 1 - 2 \cdot c ( 2 m + 1 )$$

where the pseudo-random sequence generator is initialized with

$${c}_{init} = ( {2}^{17} ( {N}_{symb}^{slot} {n}_{s , f}^{μ} + l + 1 ) ( 2 {N}_{ID} + 1 ) + 2 {N}_{ID} ) mod {2}^{31}$$

where l is the OFDM symbol number within the slot, n_{s,f}^{μ} is the slot number within a frame, and N_{ID}□{0, 1, . . . , 65535} is given by the higher-layer parameter pdcch-DMRS-ScramblingID if provided. Otherwise, N=N_{ID}^{cell}.

The UE may assume that the sequence rₗ(m) is mapped to resource elements (k,l)_{p,μ} according to

$${a}_{k , l}^{( p , μ )} = {β}_{DMRS}^{PDDCH} \cdot {r}_{l} ( 3 n + {k}^{′} ) \\ k = {nN}_{sc}^{RB} + 4 {k}^{′} + 1 \\ {k}^{′} = 0 , 1 , 2 \\ n = 0 , 1 , …$$

where the following conditions are fulfilled: they are within the resource element groups constituting the PDCCH the UE attempts to decode if the higher-layer parameter precoderGranularity equals AsREG-bundle; and all resource-element groups within the set of contiguous resource blocks in the CORESET where the UE attempts to decode the PDCCH if the higher-layer parameter precoderGranularity equal allContiguousRBs. The reference point for k is: subcarrier 0 of the lowest-numbered resource block in the CORESET if the CORESET is configured by the PBCH or by the controlResourceSetZero field in the PDCCH-ConfigCommon IE; and subcarrier 0 in common resource block 0 otherwise.

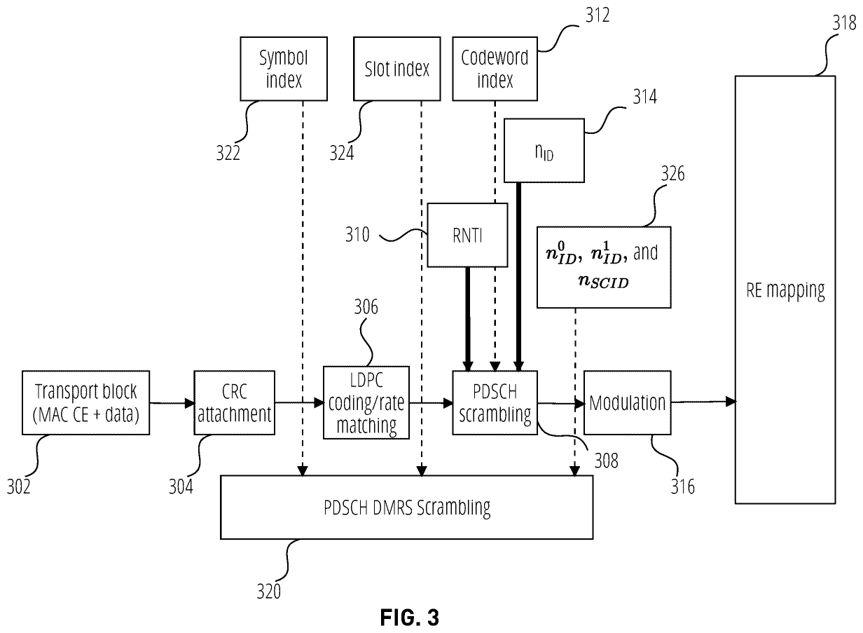

FIG. 3 is a block diagram illustrating physical layer processing of PDSCH used by certain wireless systems. The illustrated example may be performed on a DL transport block 302 (e.g., MAC CE and data) by a base station (e.g., gNB). The base station may perform CRC attachment 304 to provide error detection. The base station then performs LDPC coding/rate matching 306, wherein the base station performs low-density parity check (LDPC) coding followed by rate matching.

The base station then performs PDSCH scrambling 308 using a scrambling sequence generated from a Gold sequence. The scrambling sequence may be seeded by an RNTI 310, a codeword index 312, and a scrambling identity n_{ID} 314. The scrambling identity n_{ID} 314 may comprise, for example, a configured index similar to a cell-ID (with a slightly larger range than the cell-ID's range) or it may comprise the cell-ID itself.

For the PDSCH scrambling 308, up to two codewords, q□{0,1}, can be transmitted. In case of a single-codeword transmission, q=0. For each codeword q, the UE assumes the block of bits b^{(q)}(0), . . . , b^{(q)}(M_{bit}⁽¹⁾−1), where M_{bit}^{(q)} is the number of bits in codeword q transmitted on the physical channel, are scrambled prior to modulation, resulting in a block of scrambled bits \tilde{b}^{(q)}(0), . . . , \tilde{b}^{(q)}(M_{bit}^{(q)}−1) according to

$${\tilde{b}}^{( q )} ( i ) = ( {b}^{( q )} ( i ) + {c}^{( q )} ( i ) ) mod 2$$

where the scrambling sequence generator is initialized with

c_{RNTI}=n_{RNTI}·2¹⁵+q·2¹⁴+n_{ID}, where: n_{ID}□{0, 1, . . . , 1023} equals the higher-layer parameter dataScramblingIdentityPDSCH if configured and the RNTI equals the C-RNTI, MCS-C-RNTI, or CS-RNTI, and the transmission is not scheduled using DCI format 1_0 in a common search space; n_{ID}□{0, 1, . . . , 1023} equals the higher-layer parameter dataScramblingIdentityPDSCH if the codeword is scheduled using a CORESET with CORESETPoolIndex equal to 0 or the higher-layer parameter AdditionaldataScramblingPDSCH if the codeword is scheduled using a CORESET with CORESETPoolIndex equal to 1; if the higher-layer parameters dataScramblingIdentityPDSCH and AdditionaldataScramblingIdentityPDSCH are configured together with the higher-layer parameter CORESETPoolIndex containing two different values, and the RNTI equals the C_RNTI, MCS-C-RNTI, or CS-RNTI, and the transmission is not scheduled using DCI format 1_0 in a common search space; otherwise n_{ID}=N_{ID}^{cell}.

After the PDSCH scrambling 308, the base station performs modulation 316 to generate a block of complex-valued modulation symbols. The base station then performs RE mapping 318.

As shown in FIG. 3, the base station also performs PDSCH DMRS scrambling 320 using a Gold sequence seeded by a symbol index 322, a slot index 324, and a group of identifiers 326 including n_{ID}⁰, n_{ID}¹, n_{SCID} (which may be 16 bits or a number in a range [0, 1007]. The group of identifiers 326 may be UE specific, UE group specific, or cell specific. The pseudo-random sequence generator may be initialized with

$${c}_{init} = ( {2}^{17} ( {N}_{symb}^{slot} {n}_{s , f}^{μ} + l + 1 ) ( 2 {N}_{ID}^{{\tilde{n}}_{SCID}^{λ}} + 1 ) + {2}^{17} [ \frac{\tilde{λ}}{2} ] + 2 {N}_{ID}^{{\tilde{n}}_{SCID}^{λ}} + {\tilde{n}}_{SCID}^{λ} ) mod {2}^{31}$$

where l is the OFDM symbol number within the slot, n_{s,f}^{μ} is the slot number within a frame.

N_{ID}⁰, N_{ID}¹□{0, 1, . . . , 65535} are given by the higher-layer parameters scramblingID0 and scramblingID1, respectively, in the DMRS-DownlinkConfig IE if provided and the PDSCH is scheduled by PDCCH using DCI format 1_1 or 1_2 with the CRC scrambled by C-RNTI, MCS-C-RNTI, or CS-RNTI.

N_{ID}⁰□{0, 1, . . . , 65535} are given by the higher-layer parameter scramblingID0 in the DMRS-DownlinkConfig IE if provided and the PDSCH is scheduled by PDCCH using DCI format 1_0 with the CRC scrambled by C-RNTI, MCS-C-RNTI, or CS-RNTI; otherwise N_{ID}^{ñ}^{_{SCID}}^{^{\tilde{λ}}}=N_{ID}^{cell}.

N_{ID}^{ñ}^{_{SCID}}^{^{\tilde{λ}}} and \tilde{λ} are given by: if the higher-layer parameter dmrs-Downlink-r16 in the DMRS-DownlinkConfig IE is provided

$${\tilde{n}}_{SCID}^{λ} = \{ \begin{matrix}{n}_{SCID} & λ = 0 or λ = 2 \\ 1 - {n}_{SCID} & λ = 1\end{matrix}$$

\tilde{λ}=λ
where λ is a CDM group;
otherwise by
ñ_{SCID}^{\tilde{λ}}=n_{SCID}
\tilde{λ}=0

The quantity n_{SCID}□{0,1} is given by the DM-RS sequence initialization field, if present, in the DCI associated with the PDSCH transmission if DCI format 1_1 or 1_2 is used, otherwise n_{SCID}=0.

In certain embodiments disclosed herein, a time-varying RNTI is used to avoid detection of RNTI by an attacker through multiple observations. Certain embodiments decouple the scrambling of DMRS and payload (e.g., PDCCH, PDSCH, or physical uplink shared channel (PUSCH)). In addition, or in other embodiments, the scrambling of one physical channel is decoupled from the scrambling of another physical channel.

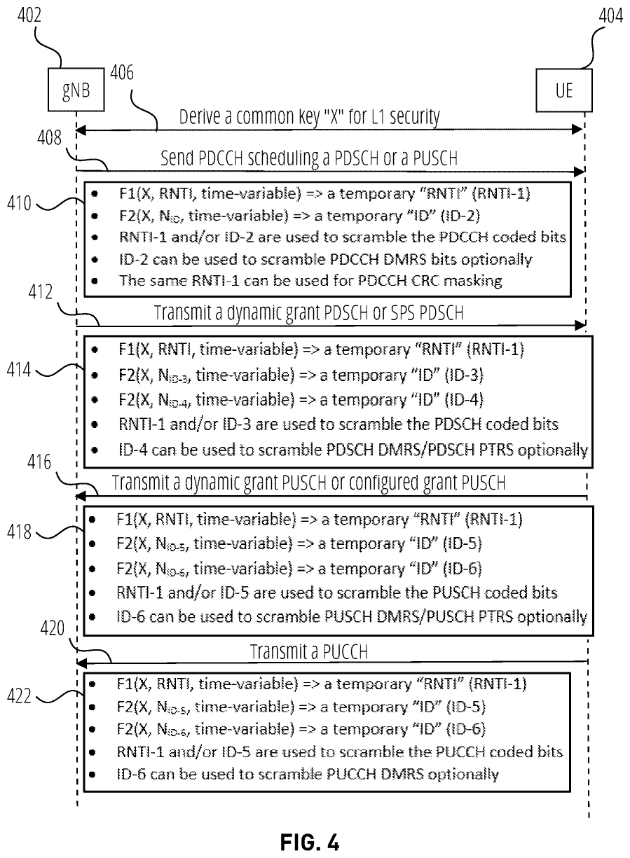

FIG. 4 is a timing diagram illustrating a process for L1 (i.e., physical layer) security according to certain embodiments. As shown, a gNB 402 and a UE 404 derive 406 a common key “X” for L1 security. As discussed below, the common key X between the gNB 402 and the UE 404 may be one of the existing keys or a newly derived key. The common key X may be the same or different for different scrambling sequences (e.g., for PDCCH, PDSCH, PUSCH, etc.). A key update may be delivered, for example, by RRC reconfiguration or by MAC CEs.

The gNB 402 may send 408 a PDCCH scheduling a PDSCH or a PUSCH to the UE 404. As shown in block 410 for physical layer processing of the PDCCH, the gNB 402 uses a first function F1 based on the common key X, the RNTI, and a time variable to generate a temporary RNTI (RNTI-1). The temporary RNTI may also be referred to herein as a first temporary ID or a time-varying RNTI-1. The gNB 402 also uses a second function F2 based on the common key X, a scrambling identity N_{ID}, and the time variable to generate a second temporary ID (ID-2). The temporary IDs (e.g., ID-2, ID-3, etc.) may also be referred to herein as time-varying IDs. The gNB 402 uses the temporary RNTI-1 and/or the temporary ID-2 to seed the scrambling sequence used to scramble the PDCCH coded bits. Optionally, in certain embodiments, the gNB 402 uses the temporary ID-2 to seed the scrambling sequence used to scramble the PDCCH DMRS bits. In addition, or in other embodiments, the same temporary RNTI-1 is used for PDCCH CRC masking.

The gNB 402 may transmit 412 a dynamic grant PDSCH or semi-persistent scheduling (SPS) PDSCH to the UE 404. As shown in block 414 for physical layer processing of the PDSCH, the gNB 402 uses the first function F1 based on the common key X, the RNTI, and the time variable to generate the temporary RNTI (RNTI-1). The gNB 402 uses the second function F2 based on the common key X, a third scrambling identity N_{ID-3}, and the time variable to generate a third temporary ID (ID-3). The gNB 402 also uses the second function F2 based on the common key X, a fourth scrambling identity N_{ID-4}, and the time variable to generate a fourth temporary ID (ID-4). The gNB 402 uses the temporary RNTI-1 and/or the third temporary ID-3 to seed the scrambling sequence used to scramble the PDSCH coded bits. Optionally, in certain embodiments, the gNB 402 uses the fourth temporary ID-4 to seed the scrambling sequence used to scramble the PDSCH DMRS bits and/or PDSCH phase tracking reference signal (PTRS) bits.

The UE 404 may transmit 416 a dynamic grant PUSCH or configured grant PUSCH to the gNB 402. As shown in block 418 for physical layer processing of the PUSCH, the UE 404 uses the first function F1 based on the common key X, the RNTI, and the time variable to generate the temporary RNTI (RNTI-1). The UE 404 uses the second function F2 based on the common key X, a fifth scrambling identity N_{ID-5}, and the time variable to generate a fifth temporary ID-5. The UE 404 also uses the second function F2 based on the common key X, a sixth scrambling identity N_{ID-6}, and the time variable to generate a sixth temporary ID (ID-6). The UE uses the temporary RNTI-1 and/or the fifth temporary ID-5 to seed the scrambling sequence used to scramble the PUSCH coded bits. Optionally, in certain embodiments, the UE 404 uses the sixth temporary identifier ID-6 to seed the scrambling sequence used to scramble the PUSCH DMRS and/or the PUSCH PTRS.

The UE 404 may transmit 420 a PUCCH to the gNB 402. As shown in block 422 for physical layer processing of the PUCCH, the UE 404 uses the first function F1 based on the common key X, the RNTI, and the time variable to generate the temporary RNTI (RNTI-1). The UE 404 uses the second function F2 based on the common key X, the fifth scrambling identity N_{ID-5}, and the time variable to generate the fifth temporary ID-5. The UE 404 also uses the second function F2 based on the common key X, the sixth scrambling identity N_{ID-6}, and the time variable to generate the sixth temporary ID (ID-6). The UE uses the temporary RNTI-1 and/or the fifth temporary ID-5 to seed the scrambling sequence used to scramble the PUCCH coded bits. Optionally, in certain embodiments, the UE 404 uses the sixth temporary identifier ID-6 to seed the scrambling sequence used to scramble the PUCCH DMRS.

In certain embodiments, the function “F” (i.e., the first function F1 and/or the second function F2) is a hash function, which takes the concatenated sequence from the inputs (e.g., X, RNTI/N_{ID}, and time variable) and generates a hash value. In other embodiments, the function “F” is an encryption function, which takes the concatenated sequence from the inputs (e.g., X, RNTI/N_{ID}, and time variable) and optionally some filler bits (e.g., fixed pattern “FFFFFFF . . . ”), and generates an encrypted message. A selected segment from the encrypted message is extracted (e.g., the first 16 bits or the second 16 bits) as the output of the encryption function.

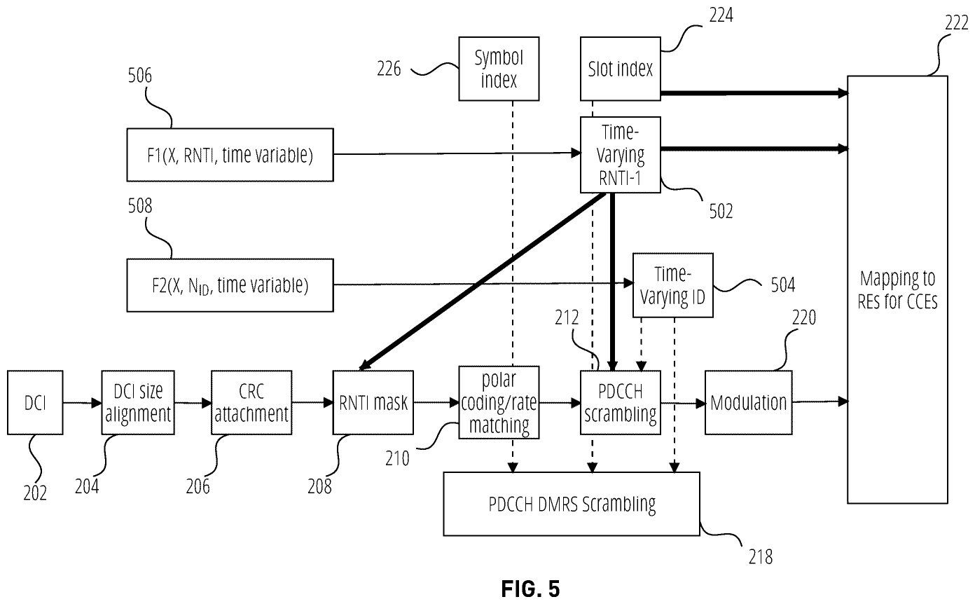

FIG. 5 is a block diagram illustrating physical layer processing of PDCCH according to certain embodiments. The elements shown in FIG. 5 may be the same as those shown and described in relation to FIG. 2, except that for the PDCCH scrambling 212 the base station uses a time-varying RNTI-1 502 and/or a time-varying ID 504 to seed the scrambling sequence used to scramble the PDCCH coded bits. Optionally, for the PDCCH DMRS scrambling 218, the base station may also use the time-varying ID 504 to seed the scrambling sequence used to scramble the PDCCH DMRS bits. In addition, or in other embodiments, the base station uses the time-varying RNTI-1 502 for the RNTI mask 208.

As discussed above with respect to FIG. 4, the base station uses a first function F1 506 based on the common key X, the RNTI, and the time variable to generate the time-varying RNTI-1 502. The base station also uses a second function F2 508 based on the common key X, the scrambling identity N_{ID}, and the time variable to generate the time-varying ID 504. Preferably, the common key X and the RNTI are unknown to an attacker. However, due to the time variable, the RNTI may not need protection. The first function F1 506 and the second function F2 508 may be seeded by the same function with different keys. Or, the first function F1 506 and the 508 may be different functions.

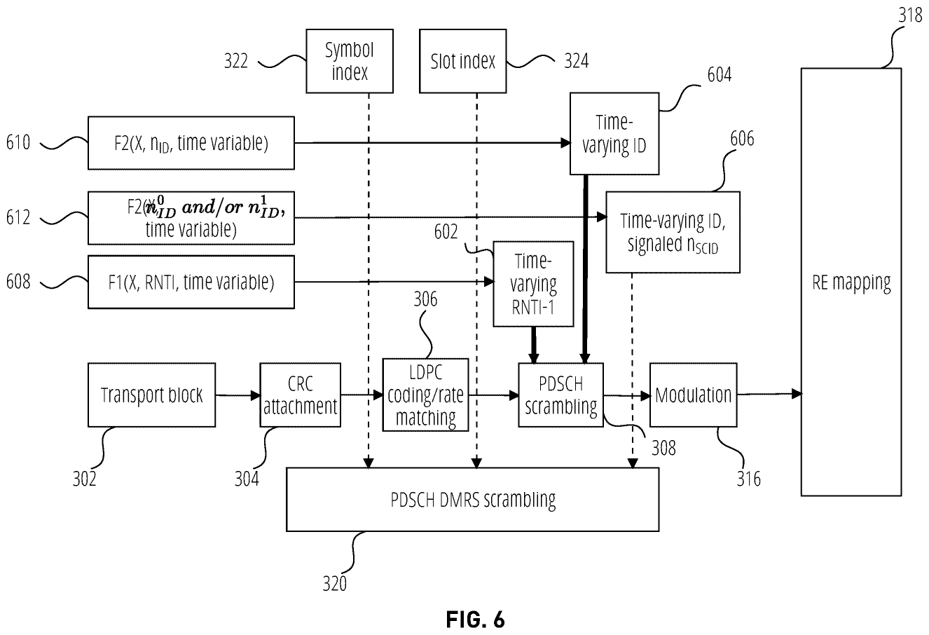

FIG. 6 is a block diagram illustrating physical layer processing of PDSCH according to certain embodiments. The elements shown in FIG. 6 may be the same as those shown and described in relation to FIG. 3, except that for the PDSCH scrambling 308 the base station uses a time-varying RNTI-1 602 and/or a time-varying ID 604 to seed the scrambling sequence used to scramble the PDSCH coded bits. Optionally, for the PDSCH DMRS scrambling 320, the base station may use another time-varying ID 606 or signaled n_{SCID} to seed the scrambling sequence used to scramble the PDSCH DMRS bits and/or PDSCH PTRS.

As discussed above with respect to FIG. 4, the base station uses the first function F1 608 based on the common key X, the RNTI, and the time variable to generate the time-varying RNTI-1 602. The base station also uses the second function F2 610 based on the common key X, the scrambling identity n_{ID}, and the time variable to generate the time-varying ID 604 used with the PDSCH scrambling 308. The base station may further use the second function F2 612 based on the common key X, scrambling identities n_{ID}⁰ and/or n_{ID}¹, and the time variable to generate the time-varying ID 606 used with the PDSCH DMRS scrambling 320.

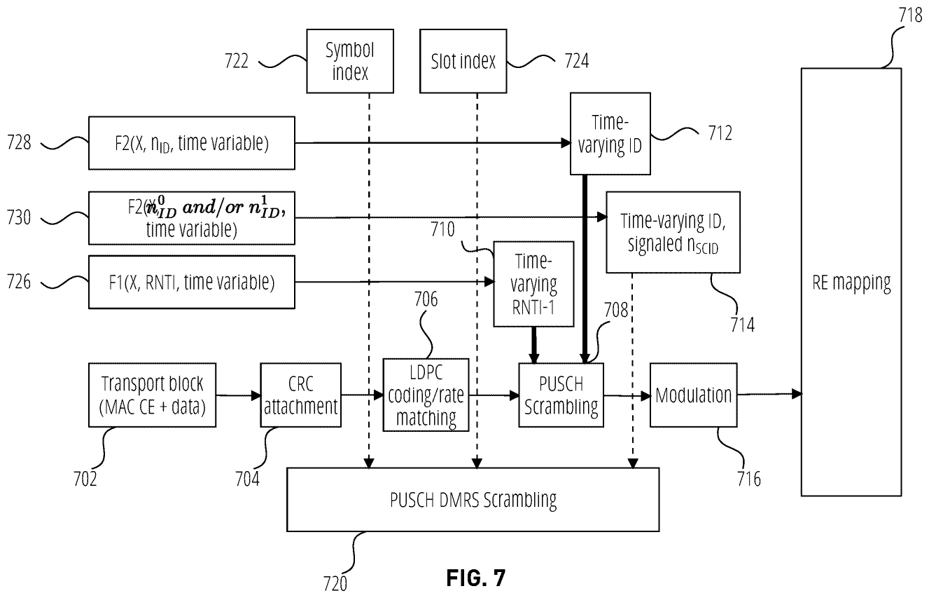

FIG. 7 is a block diagram illustrating physical layer processing of PUSCH according to certain embodiments. The illustrated example may be performed on a UL transport block 702 (e.g., MAC CE and data) by a UE. The UE may perform CRC attachment 704 to provide error detection. The UE then performs LDPC coding/rate matching 706 followed by PUSCH scrambling 708 using a scrambling sequence generated from a Gold sequence. The scrambling sequence may be seeded by a time-varying RNTI-1 710 and/or a time-varying ID 712. After the PUSCH scrambling 708, the UE performs modulation 716 to generate a block of complex-valued modulation symbols. The UE then performs RE mapping 718.

As shown in FIG. 7, the UE also performs PUSCH DMRS scrambling 720 using a Gold sequence seeded by a symbol index 722, a slot index 724. Optionally, the UE may also use another time-varying ID 714 or signaled n_{SCID} to seed the scrambling sequence used to scramble the PUSCH DMRS bits and/or PUSCH PTRS.

As discussed above with respect to FIG. 4, the UE uses the first function F1 726 based on the common key X, the RNTI, and the time variable to generate the time-varying RNTI-1 710. The UE also uses the second function F2 728 based on the common key X, the scrambling identity n_{ID}, and the time variable to generate the time-varying ID 712 used with the PUSCH scrambling 708. The UE may further use the second function F2 730 based on the common key X, scrambling identities n_{ID}⁰ and/or n_{ID}¹, and the time variable to generate the time-varying ID 714 used with the PUSCH DMRS scrambling 720.

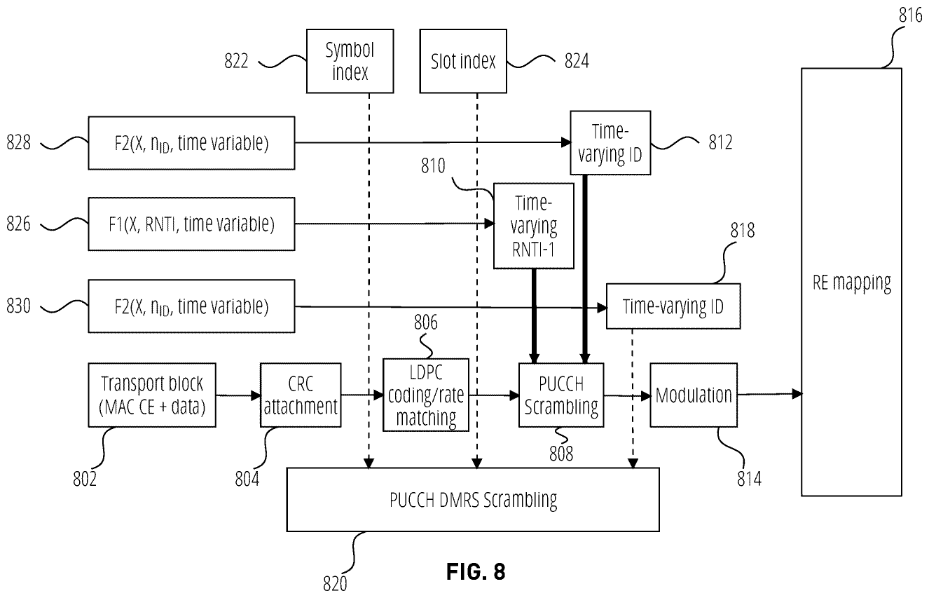

FIG. 8 is a block diagram illustrating physical layer processing of PUCCH according to certain embodiments. The illustrated example may be performed on a UL transport block 802 (e.g., MAC CE and data) by a UE. The UE may perform CRC attachment 804 to provide error detection. The UE then performs LDPC coding/rate matching 806 followed by PUSCH PUCCH scrambling 808 using a scrambling sequence generated from a Gold sequence. The scrambling sequence may be seeded by a time-varying RNTI-1 810 and/or a time-varying ID 812. After the PUSCH PUCCH scrambling 808, the UE performs modulation 814 to generate a block of complex-valued modulation symbols. The UE then performs RE mapping 816.

As shown in FIG. 8, the UE also performs PUSCH PUCCH DMRS scrambling 820 using a Gold sequence seeded by a symbol index 822, a slot index 824. Optionally, the UE may also use another time-varying ID 818 to seed the scrambling sequence used to scramble the PUCCH DMRS bits.

As discussed above with respect to FIG. 4, the UE uses the first function F1 first function 826 based on the common key X, the RNTI, and the time variable to generate the time-varying RNTI-1 810. The UE also uses the second function F2 second function 828 based on the common key X, the scrambling identity n_{ID}, and the time variable to generate the time-varying ID 812 used with the PUCCH scrambling 808. The UE may further use the second function 830 based on the common key X, the scrambling identity n_{ID}, and the time variable to generate the time-varying ID 818 used with the PUCCH DMRS scrambling 820.

Thus, as shown in FIG. 4 to FIG. 8, a base station can configure generation of time-varying RNTI and/or a time-varying identifier such as N_{ID} for at least one scrambling sequence seeding for a UE. The generation of time-varying RNTI and/or generation of time-varying ID in a scrambling sequence seeding can be applied to one or a combination of PDCCH coded bits, PDCCH DMRS, PDSCH coded bits, PDSCH DMRS, PUSCH coded bits, PUSCH DMRS, PUCCH coded bits, and/or PUCCH DMRS. The time-varying RNTI/identifier can be generated using a hash function or ciphering function with a secret key shared between the UE and the network, an RNTI/constant identifier, and a time variable.

As discussed above, the common key X between the base station and the UE may be one of the existing keys or a newly derived key. For example, the common key X may be the same as, or generated and distributed in a manner similar to, that shown in 3GPP TS 33.501 FIG. 6.2.1-1 and/or FIG. 6.2.2-2 for keys K_{RRCint}, K_{RRCenc}, K_{UPint}, and/or K_{UPenc}.

For NG-RAN, K_{gNB} is a key derived by mobile equipment (ME) and access management function (AMF) from K_{AMF}. K_{gNB} is further derived by ME and source gNB when performing horizontal or vertical key derivation. The K_{gNB} is used as K_{eNB} between Me and ng-eNB.

For user plane (UP) traffic, K_{UPenc} is a key derived by ME and gNB from K_{gNB}, which is only used for the protection of UP traffic with a particular encryption algorithm. K_{UPing} is a key derived by ME and gNB from K_{gNB}, which is only used for the protection of UP traffic between ME and gNB with a particular integrity algorithm.

For RRC signaling, K_{RRCinc} is a key derived by ME and gNB from K_{gNB}, which is only used for the protection of RRC signaling with a particular encryption algorithm. K_{RRCenc} is a key derived by ME and gNB from K_{gNB}, which is only used for the protection of RRC signaling with a particular integrity algorithm.

In certain embodiments, frequent key changes may be used to keep the system secure. For example, because the output bytes of 32 bits are small, sufficient samples of valid RNTIs for known time variables might allow the key to be reverse engineered. Thus, it may be beneficial in certain embodiments to frequently change the keys.

In certain embodiments, there may be a different common key X for different scrambling sequences (e.g., for PDCCH, PDSCH, PUSCH, etc.). Key update may be delivered by RRC Reconfiguration, wherein a new set of keys is provided along with the time (system frame number (SFN), subframe, slot) at which the keys should be swapped or take effect. In certain such embodiments, the UE may continue to use an old set of keys at slot N−1 and use new keys from slot N onward.

In another embodiment, key update may be delivered by MAC CEs. A key update CE alone can be encrypted and/or integrity protected. Alternatively, all MAC CEs may be protected.

In certain embodiments, a slot index or a symbol index within a slot may be used for the time variable used as an input of the function F (i.e., the first function F1 and/or the second function F2). To help reduce the complexity, according to other embodiments, the time variable may comprise a radio frame index and/or a slot index. In certain embodiments, the time variable comprises at least 24 bits.

In certain communication systems, the scrambling sequence may be generated by a higher order polynomial. Thus, the function F (i.e., the first function F1 and or the second function F2), in certain embodiments, can generate more than 16 bits. In addition, or in other embodiments, the L1 security scrambling may be applied in addition to, or in replacement of, any scrambling used in the current L1 process.

The scrambling generation for PDCCH with a UE specific search space (USS) may be different from that for a PDCCH with a common search space (CSS). Thus, certain embodiments disclosed herein may only be applied to PDCCH with a USS. For example, if for a N_{ID}, the cell-ID is currently used in the NR specification, then the time-varying function is not applied.

In certain embodiments, the time-varying function may be applicable to the following reference signals. For PDSCH DMRS, N_{ID}⁰, N_{ID}¹∈{0, 1, . . . , 65535} are given by the higher-layer parameters scramblingID0 and scramblingID1, respectively, in the DMRS-DownlinkConfig. For PUSCH DMRS, N_{ID}⁰, N_{ID}¹∈{0, 1, . . . , 65535} are given by the higher-layer parameters scramblingID0 and scramblingID1, respectively, in the DMRS-UplinkConfig IE. For PDCCH DMRS N_{ID}∈{0, 1, . . . , 65535} is given by the higher-layer parameter pdcch-DMRS-ScramblingID. For PUCCH DMRS, N_{ID}⁰∈{0, 1, . . . , 65535} is given by the higher-layer parameter scramblingID0 in the DMRS-UplinkConfig 1E.

In certain embodiments, the time-varying function may be applicable to the following physical channels. For PDSCH, n_{ID}∈{0, 1, . . . , 1023} equals the higher-layer parameter dataScramblingIdentityPDSCH. For PUSCH, n_{ID}∈{0, 1, . . . , 1023} equals the higher-layer parameter dataScramblingIdentityPUSCH. For PDCCH, n_{ID}∈{0, 1, . . . , 1023} equals the higher-layer parameter pdcch-DMRS-ScramblingID, if configured. For PUCCH n_{ID}∈{0, 1, . . . , 1023} equals the higher-layer parameter dataScramblingIdentityPUSCH.

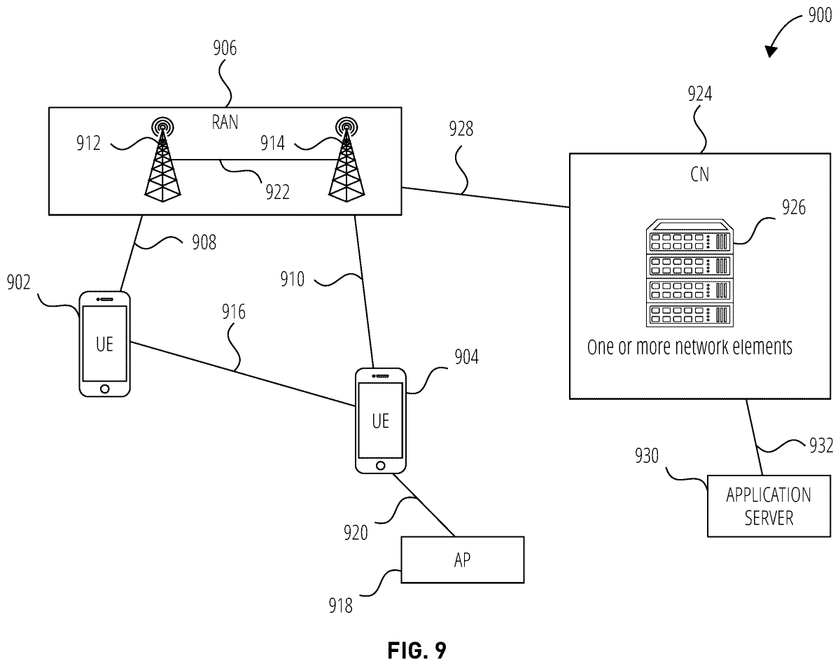

FIG. 9 illustrates an example architecture of a wireless communication system 900, according to embodiments disclosed herein. The following description is provided for an example wireless communication system 900 that operates in conjunction with the LTE system standards and/or 5G or NR system standards as provided by 3GPP technical specifications.

As shown by FIG. 9, the wireless communication system 900 includes UE 902 and UE 904 (although any number of UEs may be used). In this example, the UE 902 and the UE 904 are illustrated as smartphones (e.g., handheld touchscreen mobile computing devices connectable to one or more cellular networks), but may also comprise any mobile or non-mobile computing device configured for wireless communication.

The UE 902 and UE 904 may be configured to communicatively couple with a RAN 906. In embodiments, the RAN 906 may be NG-RAN, E-UTRAN, etc. The UE 902 and UE 904 utilize connections (or channels) (shown as connection 908 and connection 910, respectively) with the RAN 906, each of which comprises a physical communications interface. The RAN 906 can include one or more base stations (such as base station 912 and base station 914) that enable the connection 908 and connection 910.

In this example, the connection 908 and connection 910 are air interfaces to enable such communicative coupling, and may be consistent with RAT(s) used by the RAN 906, such as, for example, an LTE and/or NR.

In some embodiments, the UE 902 and UE 904 may also directly exchange communication data via a sidelink interface 916. The UE 904 is shown to be configured to access an access point (shown as AP 918) via connection 920. By way of example, the connection 920 can comprise a local wireless connection, such as a connection consistent with any IEEE 802.11 protocol, wherein the AP 918 may comprise a Wi-Fi® router. In this example, the AP 918 may be connected to another network (for example, the Internet) without going through a CN 924.

In embodiments, the UE 902 and UE 904 can be configured to communicate using orthogonal frequency division multiplexing (OFDM) communication signals with each other or with the base station 912 and/or the base station 914 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 912 or base station 914 may be implemented as one or more software entities running on server computers as part of a virtual network. In addition, or in other embodiments, the base station 912 or base station 914 may be configured to communicate with one another via interface 922. In embodiments where the wireless communication system 900 is an LTE system (e.g., when the CN 924 is an EPC), the interface 922 may be an X2 interface. The X2 interface may be defined between two or more base stations (e.g., two or more eNBs and the like) that connect to an EPC, and/or between two eNBs connecting to the EPC. In embodiments where the wireless communication system 900 is an NR system (e.g., when CN 924 is a 5GC), the interface 922 may be an Xn interface. The Xn interface is defined between two or more base stations (e.g., two or more gNBs and the like) that connect to 5GC, between a base station 912 (e.g., a gNB) connecting to 5GC and an eNB, and/or between two eNBs connecting to 5GC (e.g., CN 924).

The RAN 906 is shown to be communicatively coupled to the CN 924. The CN 924 may comprise one or more network elements 926, which are configured to offer various data and telecommunications services to customers/subscribers (e.g., users of UE 902 and UE 904) who are connected to the CN 924 via the RAN 906. The components of the CN 924 may be implemented in one physical device or separate physical devices including components to read and execute instructions from a machine-readable or computer-readable medium (e.g., a non-transitory machine-readable storage medium).

In embodiments, the CN 924 may be an EPC, and the RAN 906 may be connected with the CN 924 via an S1 interface 928. In embodiments, the S1 interface 928 may be split into two parts, an S1 user plane (S1-U) interface, which carries traffic data between the base station 912 or base station 914 and a serving gateway (S-GW), and the S1-MME interface, which is a signaling interface between the base station 912 or base station 914 and mobility management entities (MMEs).

In embodiments, the CN 924 may be a 5GC, and the RAN 906 may be connected with the CN 924 via an NG interface 928. In embodiments, the NG interface 928 may be split into two parts, an NG user plane (NG-U) interface, which carries traffic data between the base station 912 or base station 914 and a user plane function (UPF), and the S1 control plane (NG-C) interface, which is a signaling interface between the base station 912 or base station 914 and access and mobility management functions (AMFs).

Generally, an application server 930 may be an element offering applications that use internet protocol (IP) bearer resources with the CN 924 (e.g., packet switched data services). The application server 930 can also be configured to support one or more communication services (e.g., VoIP sessions, group communication sessions, etc.) for the UE 902 and UE 904 via the CN 924. The application server 930 may communicate with the CN 924 through an IP communications interface 932.

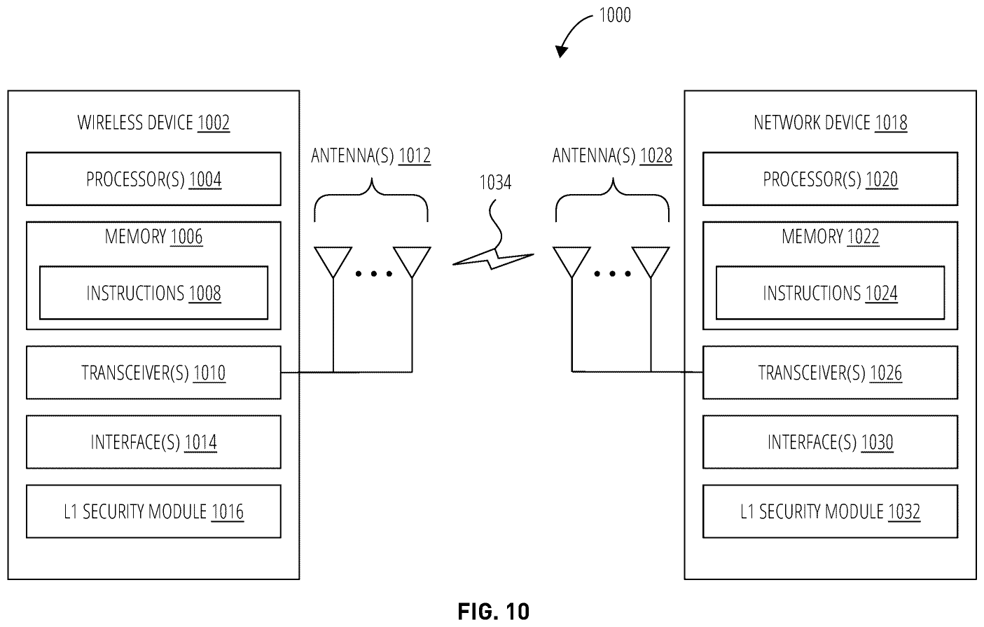

FIG. 10 illustrates a system 1000 for performing signaling 1034 between a wireless device 1002 and a network device 1018, according to embodiments disclosed herein. The system 1000 may be a portion of a wireless communications system as herein described. The wireless device 1002 may be, for example, a UE of a wireless communication system. The network device 1018 may be, for example, a base station (e.g., an eNB or a gNB) of a wireless communication system.

The wireless device 1002 may include one or more processor(s) 1004. The processor(s) 1004 may execute instructions such that various operations of the wireless device 1002 are performed, as described herein. The processor(s) 1004 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 1002 may include a memory 1006. The memory 1006 may be a non-transitory computer-readable storage medium that stores instructions 1008 (which may include, for example, the instructions being executed by the processor(s) 1004). The instructions 1008 may also be referred to as program code or a computer program. The memory 1006 may also store data used by, and results computed by, the processor(s) 1004.

The wireless device 1002 may include one or more transceiver(s) 1010 that may include radio frequency (RF) transmitter and/or receiver circuitry that use the antenna(s) 1012 of the wireless device 1002 to facilitate signaling (e.g., the signaling 1034) to and/or from the wireless device 1002 with other devices (e.g., the network device 1018) according to corresponding RATs.

The wireless device 1002 may include one or more antenna(s) 1012 (e.g., one, two, four, or more). For embodiments with multiple antenna(s) 1012, the wireless device 1002 may leverage the spatial diversity of such multiple antenna(s) 1012 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 1002 may be accomplished according to precoding (or digital beamforming) that is applied at the wireless device 1002 that multiplexes the data streams across the antenna(s) 1012 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 1002 may implement analog beamforming techniques, whereby phases of the signals sent by the antenna(s) 1012 are relatively adjusted such that the (joint) transmission of the antenna(s) 1012 can be directed (this is sometimes referred to as beam steering).

The wireless device 1002 may include one or more interface(s) 1014. The interface(s) 1014 may be used to provide input to or output from the wireless device 1002. For example, a wireless device 1002 that is a UE may include interface(s) 1014 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 1010/antenna(s) 1012 already described) that allow for communication between the UE and other devices and may operate according to known protocols (e.g., Wi-Fi®, Bluetooth®, and the like).

The wireless device 1002 may include an L1 security module 1016. The L1 security module 1016 may be implemented via hardware, software, or combinations thereof. For example, the L1 security module 1016 may be implemented as a processor, circuit, and/or instructions 1008 stored in the memory 1006 and executed by the processor(s) 1004. In some examples, the L1 security module 1016 may be integrated within the processor(s) 1004 and/or the transceiver(s) 1010. For example, the L1 security module 1016 may be implemented by a combination of software components (e.g., executed by a DSP or a general processor) and hardware components (e.g., logic gates and circuitry) within the processor(s) 1004 or the transceiver(s) 1010.

The L1 security module 1016 may be used for various aspects of the present disclosure, for example, aspects of FIG. 4, FIG. 7, and FIG. 8.

The network device 1018 may include one or more processor(s) 1020. The processor(s) 1020 may execute instructions such that various operations of the network device 1018 are performed, as described herein. The processor(s) 1020 may include one or more baseband processors implemented using, for example, a CPU, a DSP, an ASIC, a controller, an FPGA device, another hardware device, a firmware device, or any combination thereof configured to perform the operations described herein.

The network device 1018 may include a memory 1022. The memory 1022 may be a non-transitory computer-readable storage medium that stores instructions 1024 (which may include, for example, the instructions being executed by the processor(s) 1020). The instructions 1024 may also be referred to as program code or a computer program. The memory 1022 may also store data used by, and results computed by, the processor(s) 1020.

The network device 1018 may include one or more transceiver(s) 1026 that may include RF transmitter and/or receiver circuitry that use the antenna(s) 1028 of the network device 1018 to facilitate signaling (e.g., the signaling 1034) to and/or from the network device 1018 with other devices (e.g., the wireless device 1002) according to corresponding RATs.

The network device 1018 may include one or more antenna(s) 1028 (e.g., one, two, four, or more). In embodiments having multiple antenna(s) 1028, the network device 1018 may perform MIMO, digital beamforming, analog beamforming, beam steering, etc., as has been described.

The network device 1018 may include one or more interface(s) 1030. The interface(s) 1030 may be used to provide input to or output from the network device 1018. For example, a network device 1018 that is a base station may include interface(s) 1030 made up of transmitters, receivers, and other circuitry (e.g., other than the transceiver(s) 1026/antenna(s) 1028 already described) that enables the base station to communicate with other equipment in a core network, and/or that enables the base station to communicate with external networks, computers, databases, and the like for purposes of operations, administration, and maintenance of the base station or other equipment operably connected thereto.

The network device 1018 may include an L1 security module 1032. The L1 security module 1032 may be implemented via hardware, software, or combinations thereof. For example, the L1 security module 1032 may be implemented as a processor, circuit, and/or instructions 1024 stored in the memory 1022 and executed by the processor(s) 1020. In some examples, the L1 security module 1032 may be integrated within the processor(s) 1020 and/or the transceiver(s) 1026. For example, the L1 security module 1032 may be implemented by a combination of software components (e.g., executed by a DSP or a general processor) and hardware components (e.g., logic gates and circuitry) within the processor(s) 1020 or the transceiver(s) 1026.

The L1 security module 1032 may be used for various aspects of the present disclosure, for example, aspects of FIG. 4 to FIG. 6.

Embodiments contemplated herein include an apparatus comprising means to perform one or more elements of FIG. 4, FIG. 7, and FIG. 8. This apparatus may be, for example, an apparatus of a UE (such as a wireless device 1002 that is a UE, as described herein).

Embodiments contemplated herein include one or more non-transitory computer-readable media comprising instructions to cause an electronic device, upon execution of the instructions by one or more processors of the electronic device, to perform one or more elements of FIG. 4, FIG. 7, and FIG. 8. This non-transitory computer-readable media may be, for example, a memory of a UE (such as a memory 1006 of a wireless device 1002 that is a UE, as described herein).

Embodiments contemplated herein include an apparatus comprising logic, modules, or circuitry to perform one or more elements of FIG. 4, FIG. 7, and FIG. 8. This apparatus may be, for example, an apparatus of a UE (such as a wireless device 1002 that is a UE, as described herein).

Embodiments contemplated herein include an apparatus comprising: one or more processors and one or more computer-readable media comprising instructions that, when executed by the one or more processors, cause the one or more processors to perform one or more elements of the FIG. 4, FIG. 7, and FIG. 8. This apparatus may be, for example, an apparatus of a UE (such as a wireless device 1002 that is a UE, as described herein).

Embodiments contemplated herein include a signal as described in or related to one or more elements of FIG. 4, FIG. 7, and FIG. 8.

Embodiments contemplated herein include a computer program or computer program product comprising instructions, wherein execution of the program by a processor is to cause the processor to carry out one or more elements of FIG. 4, FIG. 7, and FIG. 8. The processor may be a processor of a UE (such as a processor(s) 1004 of a wireless device 1002 that is a UE, as described herein). These instructions may be, for example, located in the processor and/or on a memory of the UE (such as a memory 1006 of a wireless device 1002 that is a UE, as described herein).

Embodiments contemplated herein include an apparatus comprising means to perform one or more elements of FIG. 4 to FIG. 6. This apparatus may be, for example, an apparatus of a base station (such as a network device 1018 that is a base station, as described herein).

Embodiments contemplated herein include one or more non-transitory computer-readable media comprising instructions to cause an electronic device, upon execution of the instructions by one or more processors of the electronic device, to perform one or more elements of FIG. 4 to FIG. 6. This non-transitory computer-readable media may be, for example, a memory of a base station (such as a memory 1022 of a network device 1018 that is a base station, as described herein).

Embodiments contemplated herein include an apparatus comprising logic, modules, or circuitry to perform one or more elements of FIG. 4 to FIG. 6. This apparatus may be, for example, an apparatus of a base station (such as a network device 1018 that is a base station, as described herein).

Embodiments contemplated herein include an apparatus comprising: one or more processors and one or more computer-readable media comprising instructions that, when executed by the one or more processors, cause the one or more processors to perform one or more elements of FIG. 4 to FIG. 6. This apparatus may be, for example, an apparatus of a base station (such as a network device 1018 that is a base station, as described herein).

Embodiments contemplated herein include a signal as described in or related to one or more elements of FIG. 4 to FIG. 6.

Embodiments contemplated herein include a computer program or computer program product comprising instructions, wherein execution of the program by a processing element is to cause the processing element to carry out one or more elements of FIG. 4 to FIG. 6. The processor may be a processor of a base station (such as a processor(s) 1020 of a network device 1018 that is a base station, as described herein). These instructions may be, for example, located in the processor and/or on a memory of the base station (such as a memory 1022 of a network device 1018 that is a base station, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method for communicating in a wireless communication system, the method comprising:
generating at least one of a time-varying radio network temporary identifier (RNTI) and a time-varying identifier (ID);
seeding a scrambling sequence with the at least one of the time-varying RNTI and the time-varying ID;
scrambling a physical channel or a reference signal using the scrambling sequence; and
transmitting the physical channel or the reference signal.

2. The method of claim 1, wherein generating the time-varying RNTI comprises:
deriving a common key between a base station and a user equipment (UE); and
generating the time-varying RNTI using a first function based on the common key, an RNTI, and a time variable.

3. The method of claim 2, wherein generation of the scrambling sequence used for the physical channel or the reference signal is based on, at least in part, the common key.

4. The method of claim 2, further comprising delivering a key update of the common key in one of a radio resource control (RRC) reconfiguration and a media access control (MAC) control element (CE).

5. The method of claim 2, wherein the time variable is selected from a group comprising a slot index, a symbol index, and a radio frame index.

6. The method of claim 2, wherein the time variable comprises at least 24 bits.

7. The method of claim 2, wherein generating the time-varying ID comprises generating a first time-varying ID using a second function based on the common key, a first constant ID, and the time variable.

8. The method of claim 7, wherein at least one of the first function and the second function is selected from a group comprising a hash function and a ciphering function.

9. The method of claim 7, wherein the first constant ID comprises a scrambling ID that is UE specific, UE group specific, or cell specific.

10. The method of claim 7, wherein the physical channel comprises a physical downlink control channel (PDCCH), and wherein scrambling the physical channel comprises using at least one of the time-varying RNTI and the first time-varying ID to scramble PDCCH coded bits.

11. The method of claim 10, wherein the reference signal comprises a demodulation reference signal (DMRS), and wherein the method further comprises using the first time-varying ID to scramble PDCCH DMRS bits.

12. The method of claim 10, further comprising using the time-varying RNTI for masking PDCCH cyclic redundancy check (CRC) bits.

13. The method of claim 7, wherein the physical channel comprises a physical downlink shared channel (PDSCH), and wherein scrambling the physical channel comprises using at least one of the time-varying RNTI and the first time-varying ID to scramble PDSCH coded bits.

14. The method of claim 13, wherein generating the time-varying ID further comprises generating a second time-varying ID using the second function based on the common key, one or more second constant ID, and the time variable, wherein the reference signal comprises a demodulation reference signal (DMRS) or a phase tracking reference signal (PTRS), and wherein the method further comprises using the second time-varying ID to scramble PDSCH DMRS bits or PDSCH PTRS bits.

15. The method of claim 7, wherein the physical channel comprises a physical uplink shared channel (PUSCH), and wherein scrambling the physical channel comprises using at least one of the time-varying RNTI and the first time-varying ID to scramble PUSCH coded bits.

16. The method of claim 15, wherein generating the time-varying ID further comprises generating a second time-varying ID using the second function based on the common key, one or more second constant ID, and the time variable, wherein the reference signal comprises a demodulation reference signal (DMRS) or a phase tracking reference signal (PTRS), and wherein the method further comprises using the second time-varying ID to scramble PUSCH DMRS bits or PUSCH PTRS bits.

17. The method of claim 7, wherein the physical channel comprises a physical uplink control channel (PUCCH), and wherein scrambling the physical channel comprises using at least one of the time-varying RNTI and the first time-varying ID to scramble PUCCH coded bits.

18. The method of claim 17, wherein generating the time-varying ID further comprises generating a second time-varying ID using the second function based on the common key, one or more second constant ID, and the time variable, wherein the reference signal comprises a demodulation reference signal (DMRS), and wherein the method further comprises using the second time-varying ID to scramble PUCCH demodulation reference signal (DMRS) bits.

19-21. (canceled)
